(19) United States
(12) Patent Application Publication
(10) Pub. No.: US 2015/0211636 A1
(43) Pub. Date: Jul. 30, 2015

(54) HIGH TEMPERATURE SEAL ASSEMBLY

(71) Applicant: METALLIC HI TEMPERATURE SEAL SYSTEMS, LLC., Whittier, CA (US)

(72) Inventors: Dashrath M. Panchal, West Covina, CA (US); Richard Wall, Whittier, CA (US)

(73) Assignee: METALLIC HI TEMPERATURE SEAL SYSTEMS, LLC., Whittier, CA (US)

(21) Appl. No.: 14/167,630

(22) Filed: Jan. 29, 2014

(51) Int. Cl. F16J 15/02; B64D 45/00

(52) U.S. Cl. CPC F16J 15/025; B64D 45/00; B64D 2045/009

(57) ABSTRACT

A seal assembly is configured to be installed in a sealing element retainer that includes a channel defined by a bottom wall and a pair of parallel longitudinal side walls. The seal assembly includes a sealing element having an elongate, arcuate spring portion defining a longitudinal axis, and a planar base portion, integral with the arcuate spring portion, that underlies the arcuate spring portion along the longitudinal axis and that is dimensioned to fit in the channel. A retention element is configured for engagement with the base portion of the sealing element to retain the sealing element in the channel.

### CROSS-REFERENCE TO RELATED APPLICATION

Not applicable.

### FEDERALLY-SPONSORED RESEARCH OR DEVELOPMENT

Not applicable

### BACKGROUND

The present disclosure relates to sealing devices. More specifically, it relates to a high-temperature seal assembly for use especially in aerospace applications.

High temperature seals in aerospace applications, such as for use inside jet engines, are most commonly made of elastomeric materials. However, the elastomeric materials are limited to a maximum operating temperature of about 260° C. (500° F.). These materials may also present challenges in obtaining safety certifications. For example, these materials may produce outgases and cause backside ignition—both of which constitute test failure. In addition, these elastomeric seals require a complex process to produce, with varying material usage and weights.

It would therefore be advantageous, and an advance in the state of the art, to provide a sealing element that is capable of maintaining its structural integrity and sealing function at elevated temperatures, such as those encountered inside jet engines. It would also be advantageous to provide a sealing element having these characteristics, and that is further configured for or adapted to retrofit applications, in which the high-temperature sealing element may be installed as a replacement for an existing elastomeric sealing element.

### SUMMARY

Broadly, this disclosure relates to a seal assembly comprising a sealing element configured as an elongate spring of high-temperature metal alloy and having a portion that removably fits in a standard aerospace sealing element retainer, and a retention element configured to hold the sealing element in the retainer. The sealing element, in some embodiments, includes an elongate, arcuate spring portion defining a longitudinal axis, and a planar base portion, integral with the arcuate spring portion, that underlies the arcuate spring portion along the longitudinal axis, and that is joined to the arcuate spring portion along a continuous curve forming a longitudinal transition portion, whereby the sealing element forms a unitary structure that resembles the numeral “2” in cross-section. In some embodiments, the arcuate spring portion may be described as “semi-tubular,” defined, for the purposes of this disclosure, as an elongate, partially cylindrical shape that is less than a full circle in cross-section. The base portion has a width dimensioned to seat within a standard aerospace sealing element retainer, and the retention element fits within the retainer over the base portion and captures the base portion against the retainer. Specifically, the retainer includes a bottom wall and a pair of parallel longitudinal side walls that define a shallow channel. The retention element seats on top of the base portion and engages the inside of the transition portion of the sealing element and the side wall opposite the transition portion, so that the base portion is captured between the retention element and the bottom wall of the retainer.

### BRIEF DESCRIPTION OF THE DRAWINGS

FIG. 1 is a front elevation view of a seal assembly comprising a sealing element in accordance with a first embodiment of the present disclosure, a retention element, and a sealing element retainer;

FIG. 2 is a front elevation view of the seal assembly of FIG. 1, showing the sealing element and retention element being installed in the retainer;

FIG. 3 is a side and top perspective view of the seal assembly of FIG. 1;

FIG. 4A is a top and side perspective view of the sealing element of the seal assembly shown in FIG. 1;

FIG. 4B is a perspective view of the retention element of the seal assembly shown in FIG. 1;

FIG. 4C is a top and side perspective view of the sealing element retainer shown in FIG. 1;

FIG. 5 is a side elevation view of the seal assembly of FIG. 1;

FIG. 6 is a perspective view of a sealing element in accordance with a second embodiment of this disclosure;

FIG. 7 is a cross-sectional view taken along line 7-7 of FIG. 6;

FIG. 8 is a bottom plan view of the sealing element of FIG. 6; and

FIG. 9 is a view similar to that of FIG. 6, but showing the sealing element in a curved configuration.

### DETAILED DESCRIPTION

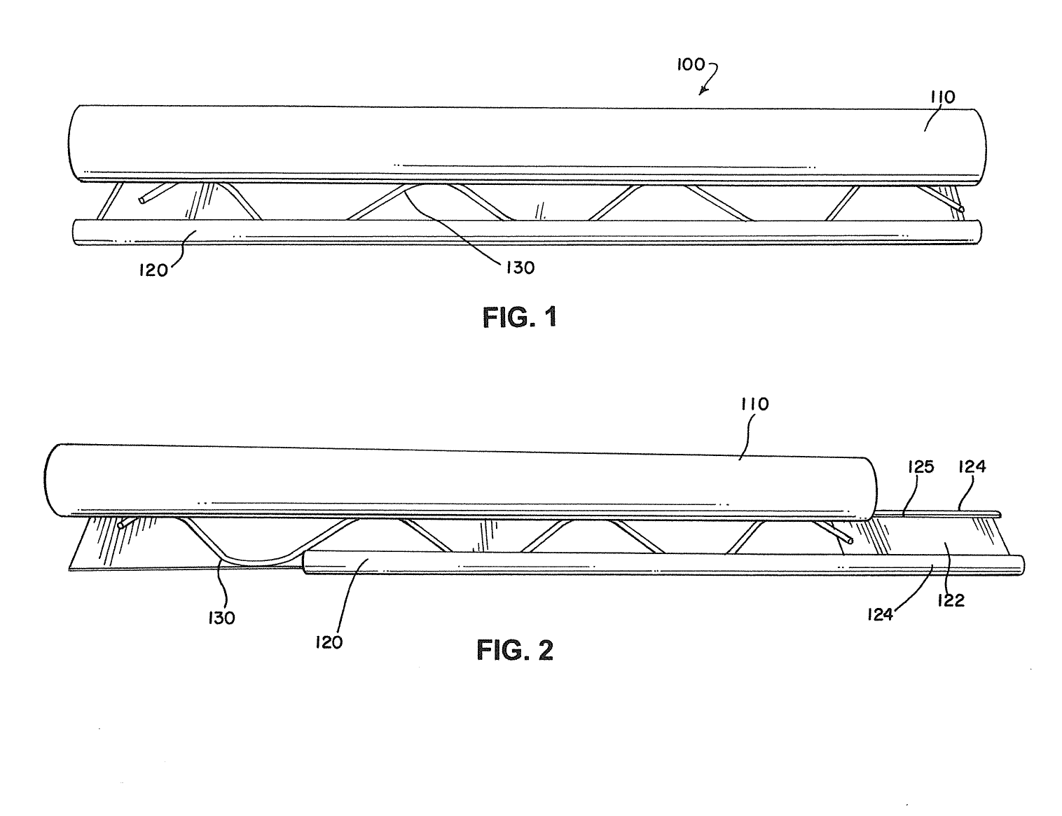

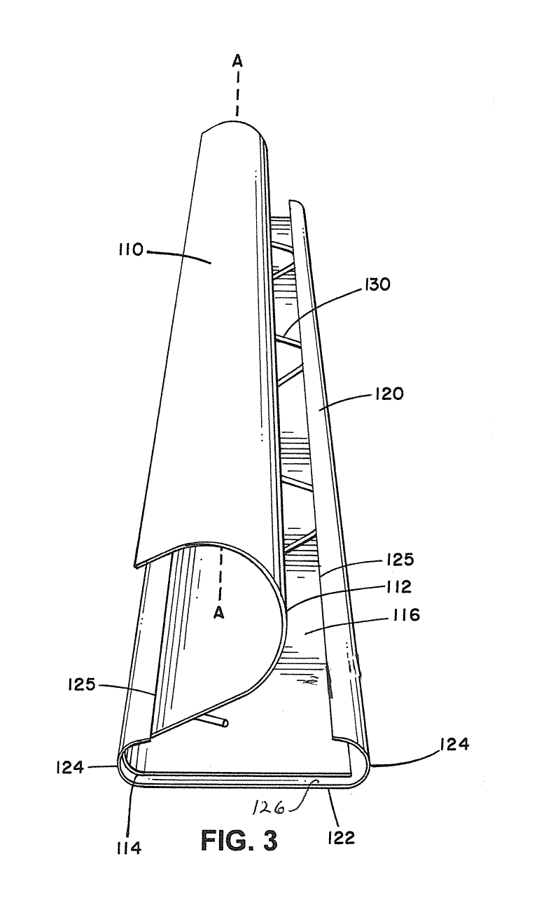

FIGS. 1-5 illustrate a seal assembly 100 in accordance with a first embodiment of the present disclosure. The seal assembly 100 includes a sealing element 110 configured to provide a gas-tight seal between structural elements (not shown). The sealing element 110 may be a high temperature seal or a fire seal, for example. In some embodiments, the sealing element 110 may be composed of a material suitable for use at operating temperatures in excess of 260° C. (500° F.). For example, in some embodiments the sealing element 110 may be made of a material suitable for use at operating temperatures of at least about 500° C. (900° F.). Typically, high spring-strength, high temperature metal alloys are suitable. One such alloy is the austenitic nickel-chromium superalloy marketed under the trademark INCONEL® 718 by Special Metals Corporation of New Hartford, N.Y.

The seal assembly 100 also includes a sealing element retainer 120 configured for securing and retaining the sealing element 110, retaining it in position, and controlling its deformation under stress. The retainer 120 may likewise be composed of a metal alloy material suitable for use at operating temperatures in excess of 260° C. (500° F.), such as INCONEL® 718, for example. Of course, other materials may be selected based on the operating requirements for a desired application. For example, in some embodiments, the retainer 120 may be stainless steel, such as 0.635 mm (0.025 in.) thick 321 stainless steel per AMS 5510.

The seal assembly 100 of this disclosure may be used in a variety of applications, including but not limited to, aerospace, automotive, domestic and commercial applications. For example, in some embodiments, the seal assembly 100 may be used as a gas-tight fire seal in a thrust reverser of a jet aircraft engine.

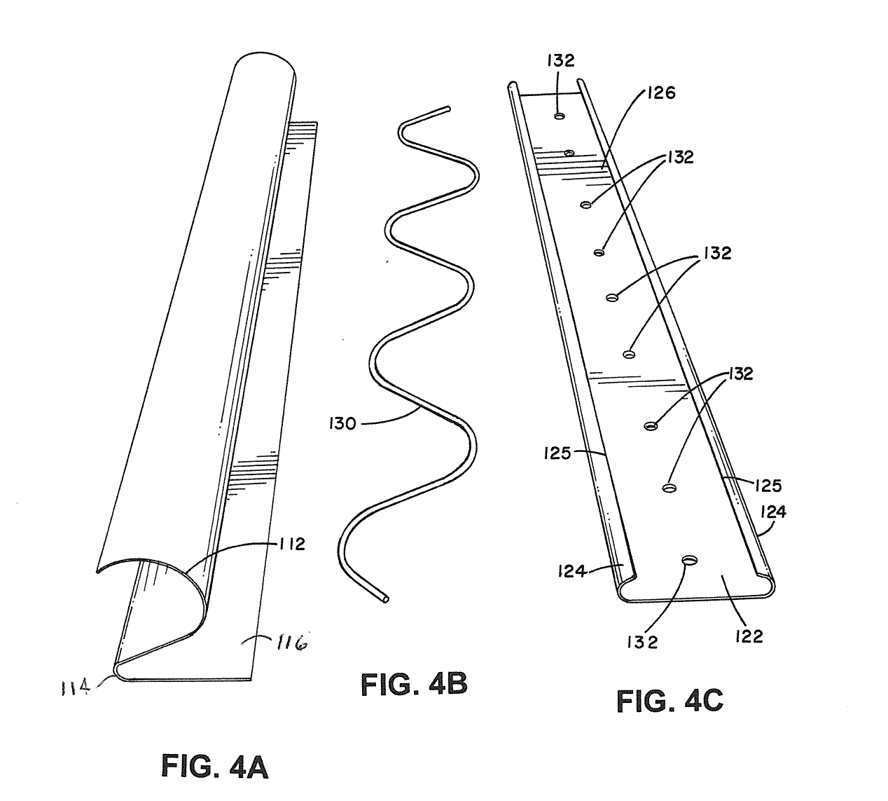

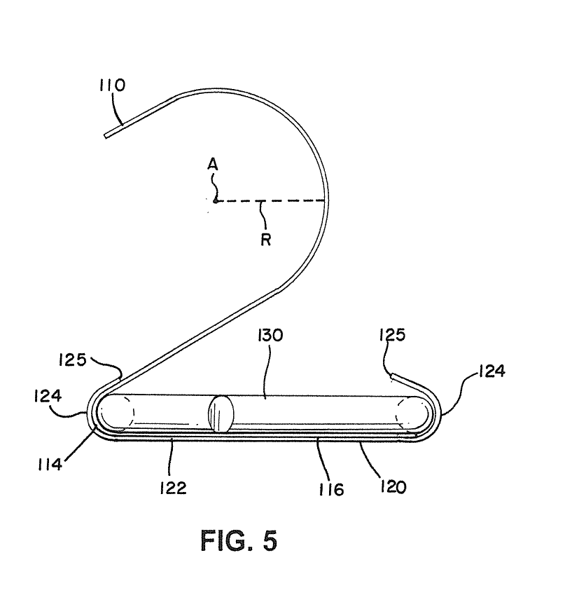

As shown in FIGS. 1, 2, 3, 4A, and 5, the sealing element 110 according to an embodiment of this disclosure, as mentioned above, is advantageously made from a unitary sheet of high temperature, high spring-strength metal alloy, such as INCONEL® 718 that is bent or otherwise formed into a suitable shape. In accordance with the illustrated exemplary embodiment, the sealing element 110 comprises a semi-tubular (as defined above) arcuate spring portion 112 that defines a longitudinal axis A (perpendicular to the drawing sheet in FIG. 5) and a radius of curvature R (FIG. 5), and that is joined along substantially its entire length, by a longitudinal curve or bend 114 that forms a continuous transition portion to a flat or planar base portion 116. As can best be seen in FIGS. 4A and 5, the unitary sealing element structure resembles the numeral “2” when viewed from one of its two ends, i.e., the end at the left side of FIGS. 1 and 2.

In some embodiments, the metal sheet may be an INCONEL® 718 sheet of about 0.4 mm (0.016 in.) in thickness, advantageously tempered per AMS 5699. Other alloys, sheet thicknesses, and tempering standards may be employed, depending on the specific application. In some embodiments, the metal sheet material may be selected to be within the elastic modulus range for the required operating temperature. For example, in an aerospace application, the metal sheet material may be selected to be within its elastic modulus range for operating temperatures of at least about 500° C. (900° F.). The size of the sealing element 110 may also selected according to the desired application. For example, in some embodiments, the sealing element 110 may have an outside diameter of approximately 25 mm (0.98 in.). In some embodiments, a protective coating, such as a tungsten carbide plasma spray RA 150, for example, may be applied to the outer surface of the sealing element 110 to improve wear resistance.

FIGS. 1, 2, 3, 4C, and 5 illustrate a sealing element retainer 120 in accordance with an embodiment of the present disclosure. The retainer 120 may advantageously be configured as a conventional sealing element retainer, of the type currently used with elastomeric sealing elements. Accordingly, the retainer will include a substantially flat bottom wall 122 and a pair of opposed parallel side walls 124, each having a free edge 125. The free edges 125 define between them a top opening into the channel 126. Each of the side walls 124 is preferably bent in an inwardly-directed curve, thereby defining, with the bottom wall 122, a channel 126 that is open at each end. The radius of curvature of the side walls 124 is preferably approximately the same as that of the bend 114 in the sealing element 110, and the base portion 116 of the sealing element 110 has a width that is slightly less than that of the channel 126, so that the base portion 116 may be slid into one of the open ends of the channel to be seated against the bottom wall 122. Alternatively, if the width of the base portion 116 is less than the width of the top opening defined between the free edges 125 of the side walls 124, the base portion 116 may be inserted into the channel 126 through the top opening.

The width of the retainer 120 is selected according to the dimensions of the sealing element 110 to be retained therein. Conventional retainers typically have a width, for example, that allows an elastomeric sealing element of a particular diameter to be seated within the retainer with a firm interference fit. When used with metallic spring sealing element 110 of the present disclosure, for a sealing element 110 having a spring portion 112 with a radius R of 12.5 mm and a base portion having a width of about 25 mm, a retainer 120 having a channel 126 with a width of approximately 27 mm may be selected.

The sealing element 110 is retained in the channel 126 of the retainer 120 by a retention element 130, best shown in FIGS. 1, 2, 3, and 4B, that, when installed, extends longitudinally within the channel 126 in engagement with the base portion 116 of the sealing element 110. In the illustrated exemplary embodiment, the retention element 130 is in the form of a thin metal rod or a thick metal wire formed into a substantially sinusoidal configuration, although other configurations may be suitable. This construction allows the retention element 130 to be flexible, so that it may be bent into a curved configuration, if desired (as will be explained below).

The maximum width of the retention element 130 is slightly greater than that of the base portion 116 of the sealing element 110, and slightly less than that of the channel 126 of the retainer 120. In the illustrated sinusoidal embodiment, the maximum width is defined by twice the amplitude of the sinusoidal curve formed by the retention element 130. The maximum width of the retention element 130 is such as to allow the retention element 130 to be inserted into one of the open ends of the channel 126 after the sealing element 110 has been installed therein, as described above, thereby to seat against the base portion 116, and to be captured between the bend 114 of the sealing element 110 and the support member side wall 124 opposite the bend 114, as best shown in FIG. 5. This arrangement thus captures the base portion 116 of the sealing element 110 between the retention element 130 and the bottom surface 122 of the retainer 120, thereby assuring that the sealing element 110 does not separate from the retainer 120. The retention element 130 may advantageously be made of the same material as the sealing element 110 and/or the retainer 120. If all three components are of the same material, the entire seal assembly 100 will have a substantially uniform coefficient of thermal expansion, thereby minimizing thermal stresses at elevated temperatures.

As shown in FIG. 4C, the bottom wall 122 of the retainer 120 may be provided with a linear array of apertures 132, each of which is dimensioned to receive a fastener (not shown) to fasten the support element 120 to a host structure (not shown). For example, in some embodiments the fasteners may be rivets, nuts, or another type of fastener. In one embodiment, the fasteners are of the type sold under the trademark Hi-Lok® by Hi-Shear Corp. of Torrance, CA. The apertures 132 may advantageously be provided along a longitudinal centerline of the bottom wall 122, as shown in FIG. 4C. The position and number of the apertures 132 are exemplary only, and not limiting.

Installation of the seal assembly 100 is as follows: The retainer 120 is first fastened or fixed to a first structural member or host structure (not shown), as discussed above. In many applications, the retainer 120 may be a pre-installed retainer from which a conventional elastomeric sealing element has been removed. In the latter case, installation begins with inserting the base portion 116 of the sealing element into the channel 126, either by sliding it through one of the open ends of the channel 126, or by inserting the base portion 116 into the channel 126 from the top opening defined between the free edges 125 of the side walls 124 of the retainer 120, if the width of the base portion 116 is less than the width of the top opening. Finally, the retention element 130 is slid into the channel 126 through one of the open ends thereof, so as to seat on top of the base portion 116. When the seal assembly 100 is installed on the host structure, a second structural member (not shown), installed so as to capture the seal assembly 110 between itself and the host structure, applies a load or compression force to the spring portion 112 of the sealing element 110, resulting in a seal being created by the sealing element 110 between the host structure and the structural member.

One aspect of a method for making a high temperature seal assembly in accordance with the present disclosure includes: (a) providing a sealing element retainer 120 on a host structure, the retainer having a bottom wall 122 and opposed side walls 124 defining a longitudinal channel 126; (b) providing a sealing element 110 including an arcuate, semi-tubular, load-bearing spring portion 112 and an integral planar base portion 116; (c) installing the base portion 116 of the sealing element 110 into the channel 126 of the retainer 120, whereby the sealing element 110 is retained within the channel 126 seated against the bottom wall 122 of the retainer 120; and (d) installing a retention element 130 in the channel 126 so as to capture the base portion 116 of the sealing element 110 against the bottom wall 122 of the retainer 120. In this configuration, the spring portion 112 of the sealing element 110 is positioned to receive a load, thereby compressing the sealing element 110 within the retainer 120.

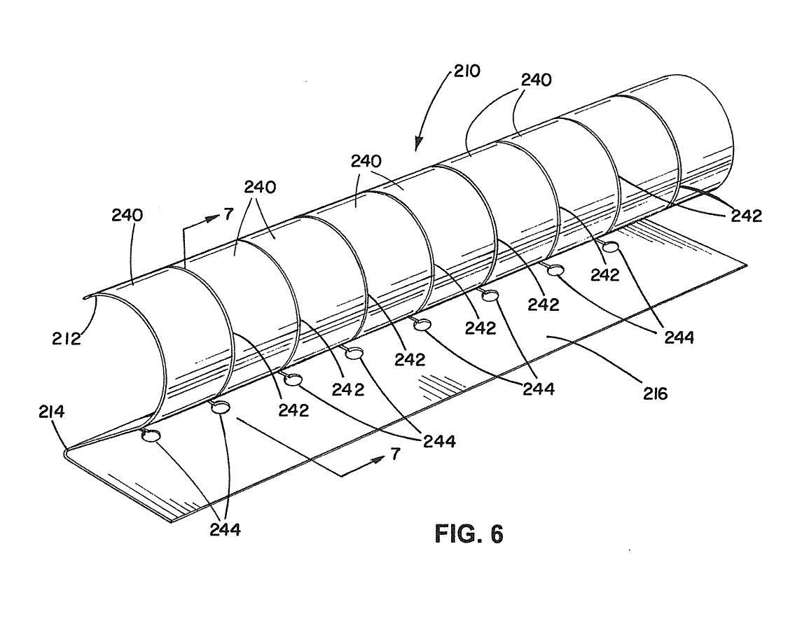

The above-described embodiment is suitable for applications in which the seal assembly is disposed substantially linearly, i.e., with little or no curvature between the host structure and the structural member with which a seal is to be effected. FIGS. 6-9 illustrate a sealing element 210 in accordance with second embodiment that is advantageous in applications in which the seal assembly must accommodate a curved juncture between the host structure and the structural member, although the sealing element 210 may also be used in a straight or linear juncture. It is understood that the sealing element 210 may be installed in the above-described retainer 120, which is linear (non-curved), or in a corresponding retainer (not shown) that is identical to the retainer 120, but which defines an arc of curvature from end-to-end. It also understood that the sealing element 210 is advantageously made of the same high-temperature metal alloy as is used for fabricating the above-described embodiment of FIGS. 1-5.

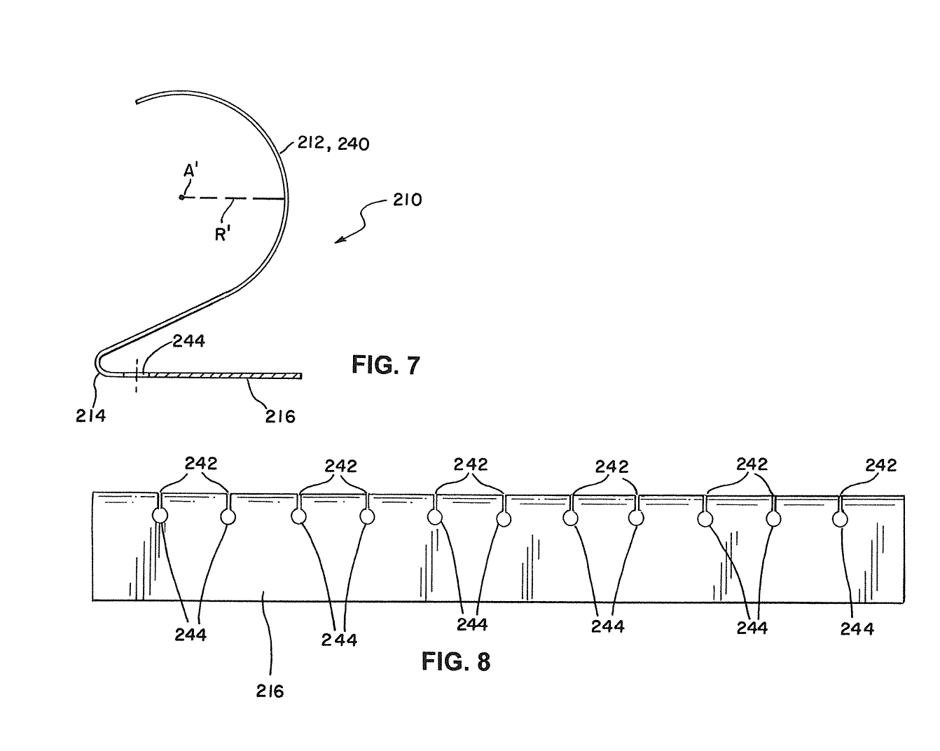

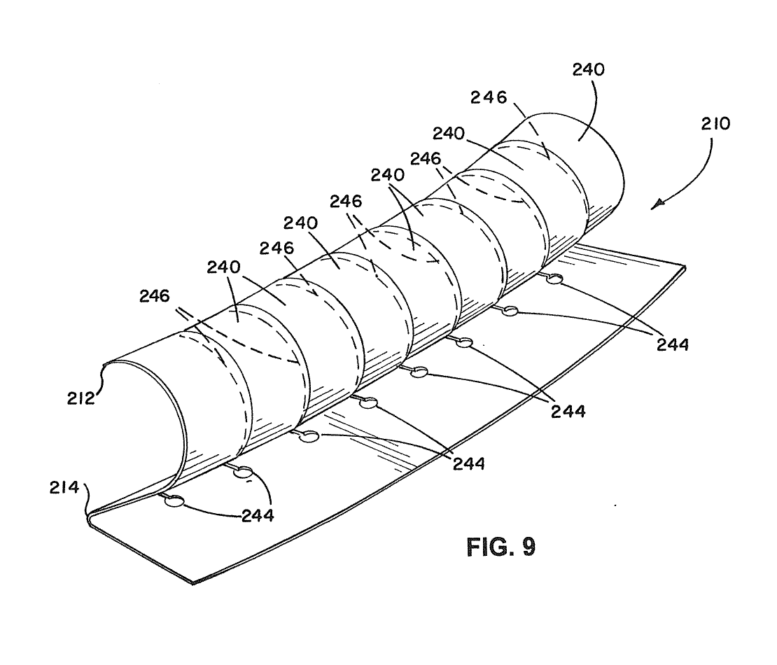

In accordance with the exemplary embodiment shown in FIGS. 6-9, the sealing element 210 comprises a semi-tubular (as defined above) arcuate spring portion 212 that defines a longitudinal axis A′ (perpendicular to the drawing sheet in FIG. 7) and a radius of curvature R′ (FIG. 7), and that is joined along substantially its entire length, by a longitudinal bend 214, to a flat or planar base portion 216. As can best be seen in FIG. 7, the unitary sealing element structure resembles the numeral “2” in cross-section orthogonal to the axis A′, or when viewed from one of its two ends, i.e., the end at the left side of FIGS. 6 and 9.

The sealing element 210 of FIGS. 6-9 differs from the sealing element 110 of FIGS. 1-5 principally in that the arcuate spring portion 212 of the former is divided along the axis A′ into a plurality of arcuate spring segments 240, each separated from the adjacent spring segment(s) by a narrow gap 242. Each of the gaps 242 extends a short distance into the base portion 216, terminating in an aperture 244 proximate the longitudinal bend 214. This segmented structure allows adjacent segments 240 to close the gaps 242 and overlap, as indicated by the dashed lines 246 in FIG. 9, when a bending force is applied to the ends of the sealing element 210, thereby facilitating the sealing element 210 assuming a curved configuration. Such a bending force may be applied, for example, when the sealing element 210 is inserted into a curved retainer. Once inserted into the retainer, the sealing element 210 may be retained therein by the above-described retention element 130, which, as noted above, is sufficiently flexible to assume the requisite curvature when inserted into the retainer over the base portion 216 of the sealing element 210. Thus, the method of installation of the sealing element 210 of FIGS. 6-9 is essentially the same as that of the sealing element 110 of FIGS. 1-5.

The above description presents the best mode contemplated for carrying out the present seal assembly, and of the manner and process of making and using it, in such full, clear, concise, and exact terms as to enable any person skilled in the art to which it pertains to make and use the seal assembly. The seal assembly is, however, susceptible to modifications and alternate constructions that are equivalent to those discussed above. Consequently, this disclosure is not limited to the particular embodiments described and illustrated herein. On the contrary, this disclosure encompasses all modifications and alternate constructions coming within the spirit and scope of the following claims, which particularly point out and distinctly claim the subject matter of this disclosure.

What is claimed is:

1. A seal assembly configured to be installed in a sealing element retainer that includes a channel defined by a bottom wall and a pair of parallel longitudinal side walls, the seal assembly comprising:
a sealing element comprising an elongate, arcuate spring portion defining a longitudinal axis, and a planar base portion, integral with the arcuate spring portion, that underlies the arcuate spring portion along the longitudinal axis and that is dimensioned to fit in the channel; and
a retention element configured for engagement with the base portion of the sealing element to retain the sealing element in the channel.

2. The seal assembly of claim 1, wherein the elongate, arcuate spring portion and the base portion are continuously joined to each other along a transition portion formed as a longitudinal bend.

3. The seal assembly of claim 2, wherein the arcuate spring portion is semi-tubular in configuration, and wherein the spring portion, the transition portion, and the base portion a form a unitary structure that resembles the numeral “2” in cross-section.

4. The seal assembly of claim 1, wherein the retention element extends longitudinally along the length of the base portion.

5. The seal assembly of claim 1, wherein the sealing element is formed from a unitary sheet of a metal alloy spring material.

6. The seal assembly of claim 5, wherein the metal alloy spring material is suitable for use at an operating temperature of at least about 260° C.

7. The seal assembly of claim 5, wherein the metal alloy spring material is primarily an austenitic nickel-chromium superalloy.

8. The seal assembly of claim 1, wherein the retention element is configured to capture the base portion of the sealing element against the bottom wall of the retainer.

9. The seal assembly of claim 8, wherein the retention element comprises a rod or wire configured to seat within the channel on top of the base portion of the sealing element and to engage one of the side walls of the retainer.

10. The seal assembly of claim 9, wherein the retention element defines a substantially sinusoidal curve.

11. The seal assembly of claim 10, wherein:
the sinusoidal curve has an amplitude;
the retention element has a maximum width defined by twice the amplitude; and
the base portion has a first width, the channel has a second width greater than the first width, and the maximum width of the retention element is slightly greater than the first width and slightly less than the second width.

12. The seal assembly of claim 1, wherein the elongate arcuate spring portion is divided along the longitudinal axis into a plurality of arcuate spring segments.

13. A seal assembly configured to be installed in a sealing element retainer that includes a channel defined by a bottom wall and a pair of parallel longitudinal side walls, the seal assembly comprising:
a sealing element comprising an elongate, semi-tubular, load-bearing spring portion defining a longitudinal axis and a planar base portion, integral with the spring portion, that underlies the spring portion along the longitudinal axis; and
a retention element configured to fit within the channel in engagement with the base portion of the sealing element and with one of the longitudinal side walls of the retainer.

14. The seal assembly of claim 13, wherein the sealing element is formed from a unitary sheet of a metal alloy spring material.

15. The seal assembly of claim 14, wherein the metal alloy spring material is suitable for use at an operating temperature of at least about 260° C.

16. The seal assembly of claim 15, wherein the metal alloy spring material is primarily an austenitic nickel-chromium superalloy.

17. The seal assembly of claim 13, wherein the elongate, semi-tubular, load-bearing spring portion is divided along the longitudinal axis into a plurality of arcuate spring segments.

18. The seal assembly of claim 13, wherein the retention element comprises a rod or wire configured to seat within the channel on top of the base portion of the sealing element and to engage one of the side walls of the retainer.

19. The seal assembly of claim 18, wherein the retention element defines a substantially sinusoidal curve.

20. The seal assembly of claim 19, wherein:
the sinusoidal curve has an amplitude;
the retention element has a maximum width defined by twice the amplitude; and
the base portion has a first width, the channel has a second width greater than the first width, and the maximum width of the retention element is slightly greater than the first width and slightly less than the second width.
